(19) United States
(12) Patent Application Publication
(10) Pub. No.: US 2009/0055521 A1
(43) Pub. Date: Feb. 26, 2009

(54) METHOD FOR MANAGING NETWORK CONNECTION AND INFORMATION PROCESSING APPARATUS

(75) Inventor: Yumiko NAKATSURU, Asaka-shi (JP)

Correspondence Address: SIDLEY AUSTIN LLP, 717 NORTH HARWOOD, SUITE 3400, DALLAS, TX, 75201, US

(73) Assignee: Konica Minolta Holdings, Inc., Tokyo (JP)

(21) Appl. No.: 12/190,119

(22) Filed: Aug. 12, 2008

(30) Foreign Application Priority Data
Aug. 24, 2007 (JP) 2007-218203

(51) Int. Cl. G06F 15/173

(52) U.S. Cl. 709/223; 709/238

(57) ABSTRACT

In a network system where a plurality of nodes are connected to each other based on a connection table stored in each of the nodes, provided are a method of managing network connections and an information processing apparatus where connection paths between the nodes can be maintained and thereby preventing an accident such as the network being split even in the situation of a sudden disconnection of a node, and there is no need for holding the connection paths more than needed. By transmitting and receiving connection information between the nodes at a prescribed timing, and by updating the stored connection tables based on the received connection information, connection paths, between each pair of nodes, that do not pass through the same node can be maintained to be a prescribed number or more.

This application is based on Japanese Patent Application No. 2007-218203 filed on Aug. 24, 2007, in Japanese Patent Office, the entire content of which is hereby incorporated by reference.

### TECHNICAL FIELD

The present invention relates to a method for managing network connection in a network system carrying out communication among a plurality of nodes based on connection tables, and to an information processing apparatus as the node in such a network system.

### BACKGROUND

In recent years, there have been popularly used networks having a communication form in which carried out are transmission and reception of data freely between arbitrary nodes constituting the network.

Conventionally, centralized processing type networks were the majority in which there was a server having a role of a host and different terminals as clients each accessed the host, where if there was a need for communication between the nodes, it was made with an intervention of the host server.

In contrast with this, there have appeared distributed processing type networks in which data communication is made freely between the different nodes constituting the network in order to distribute information and processing of the information.

A form of communication network called P2P (Peer to Peer) is a typical form of such networks. P2P is a utilization form of a network in which direct exchange of information is made between an unspecified number of nodes.

In such a distributed processing type of network form, data is stored in a distributed manner among an arbitrary number of nodes, and data transmission and reception is made mutually between them. Because of this, the degree of freedom of the form of use of the network system has increased, and the users have obtained a significant convenience in use.

For example, in the above P2P network system, because data is shared among a plurality of nodes, and the data is transmitted and received mutually between the nodes, it is possible to use data easily even if the data is not locally stored.

However, when each node constituting the network freely carries out communication, the possibility for problems of security to occur increases. As a consequence, normally, there is done connection management in which each node can carry out data communication with only a limited number of nodes following the connection table distributed to each node.

In such connection management using connection tables, data communication is made with any node by tracing the communication path which goes through nodes one after another like from a directly connected node to the next node which is connected to the directly connected node.

Further, in the case in which there are several locations that are geographically separated, in order to connect between networks at different locations, it is common to have a form in which a small number of representative nodes at each location communicate with the representative nodes at another location.

In such a network connection form, by the different nodes connecting mutually based on connection tables, the connection path between any nodes is maintained. However, the precondition for this is that all the nodes are operating properly, and for example, if a certain node gets disconnected from the network, the connection paths are not necessarily maintained. In other words, the network may get split, and it is possible that data communication between nodes or between locations may be interrupted.

In view of this, it is possible to think of carrying out connection management by introducing a management server, but the load on the management server may be large depending on the size of the network, and also the cost increases due to the introduction and maintenance of the management server. Furthermore, the merit that data communication can be done freely between nodes without the necessity of a manager will be lost.

In the Japanese Unexamined Patent Application Publication No. H09-8806, a method of searching for a detour path was proposed as a measure when a fault had occurred in the network and the connection path had been cut.

According to the technology described in this publication, when a fault has occurred in the network and an existing path cannot be maintained because a connection has been cut off, a detour route is searched for using a technique called flooding, and it is possible to maintain the communication between the nodes by setting up a new path.

However, when a network has been split, even if a detour path is searched for thereafter, there are cases in which it is not possible to find a new path.

Therefore, in order to make the connection paths between the nodes to be secured, there is required network system connection management that can acquire the connection paths even if a fault occurs in any node. On the other hand, if the number of connection paths is increased too much in consideration of possible faults, wasteful paths increase, a large load is placed on the network, and further, the uncertainties of security increases.

In particular, in a network form such as that of a P2P network, even though connection management is being done based on the connection table settings, disconnection and connection of nodes often occur, and situations will occur in which it is not possible to maintain appropriate connection management. For example, if some of the connection paths disappear due to disconnection of a node, the network itself gets split, and it is likely that access between some specific nodes or between some specific locations is not possible.

As a consequence, a major purpose of the present invention is to solve the above problems, and to provide a method for managing network connection and information processing apparatuses so that it is possible to carry out management of connection paths between nodes in an efficient manner.

In addition, another purpose of the present invention is to provide a method for managing network connections and information processing apparatuses so that, even if a situation occurs in which some node has become disconnected from the network, it is possible to maintain a connection path between nodes, and also, it is not necessary to hold too many connection paths.

### SUMMARY

In order to solve the above problems, the present invention has the following features.

A method for managing connection between a plurality of nodes which constitute a network, the method comprising the steps of:

providing each of the plurality of nodes with a connection table which contains connection information for connecting to one or more other nodes;

transmitting connection information from a first node of the plurality of nodes to a second node of the plurality of nodes at a predetermined timing; and

updating the connection table stored in the second node based on the connection information transmitted from the first node to the second node,

wherein the connection information is transmitted from the first node to the second node so that a number of connection paths which connect a pair of the plurality of nodes and do not pass through a same node is maintained to be a predetermined number or more.

According to another aspect of the present invention, another embodiment is an information processing apparatus as a node of a network constituted of a plurality of nodes, the information processing apparatus comprising:

a storing section which is adapted to store a connection table containing connection information for connecting to one or more other nodes;

a communication section which is adapted to communicate with said other node based on the connection table stored in the storing section;

a transmission section which is adapted to transmit connection information to said other node at a predetermined timing;

a reception section which is adapted to receive connection information from other node; and

an updating section which is adapted to update the connection table stored in the storing section based on the connection information received by the reception section, wherein the connection information is transmitted by the transmission section so that a number of connection paths which connects a pair of the plurality of nodes and do not pass through a same node is maintained to be a predetermined number or more.

### BRIEF DESCRIPTION OF THE DRAWINGS

FIG. 1 is a diagram showing the overall configuration of a network in a preferred embodiment of the present invention;

FIG. 2 is a diagram showing the configuration of a node (an information processing apparatus) constituting the network;

FIG. 3 is a diagram showing an example of the logical topology of each node constituting the network;

FIG. 4 is a diagram showing examples of the connection tables in different nodes;

FIG. 5 is a block diagram showing the functional configuration of the node;

FIGS. 6a, 6b, 6c, and 6d are diagrams for explaining the connection paths between any two nodes that do not pass through the same node in the network;

FIG. 7 is a diagram showing an example of the connection form of the entire network;

FIGS. 8a and 8b are flow charts showing a connection management procedure for processing example 1;

FIG. 9 is a diagram showing a sub-network at location A in the network of FIG. 7;

FIG. 10 is a diagram showing the situation when PC9 has left the network in FIG. 9;

FIG. 11 is a diagram showing an example of updating the connection tables in processing example 1;

FIG. 12 is a diagram showing the situation when PC9 has left the network in the case in which the connection management for processing example 1 has been carried out;

FIG. 13 is a flow chart showing a connection management procedure for processing example 2;

FIG. 14 is a diagram showing a part of the sub-network at location A in the network of FIG. 7;

FIG. 15 is a diagram showing the situation when PC6 has left the network in the case in which the connection management of processing example 2 has been carried out;

FIG. 16 is flow chart 1 showing a connection management procedure for processing example 3;

FIG. 17 is flow chart 2 showing the connection management procedures for processing example 3;

FIG. 18 is a diagram showing the sub-network at location C in the network of FIG. 7;

FIG. 19 is a diagram showing the path inquiry packet sent from PC28 to PC24, and the connection-path inquiring packet as a result returned to PC28;

FIG. 20 is diagram for explaining the connection paths in FIG. 18.

### DETAILED DESCRIPTION OF THE PREFERRED EMBODIMENT

A preferred embodiment of the present invention is explained in the following while referring to the drawings.

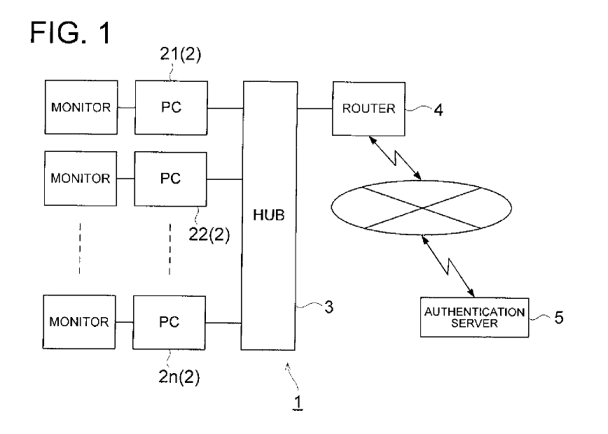

FIG. 1 is a diagram showing the overall configuration of a network 1 equipped with a network connection management method according to a preferred embodiment of the present invention.

Network 1, as is shown in FIG. 1, is a Local Area Network (LAN) constituted of a plurality of terminal devices 2 (21, 22, . . . , 2n), a switching hub 3, a router 4, and an authentication server 5, etc. The terminal devices 2 are connected in a star configuration to the switching hub 3 by twisted-pair cables.

The terminal device 2 functioning as the node of the network is an information processing apparatus, and is apparatus that executes the processing of input and output of data with other apparatuses, and can be a personal computer, a work station, or a printer, etc. In the following, the term ‘node’ refers to terminal device 2, and the explanations will be made considering that personal computers are used as the information processing apparatuses.

In the present preferred embodiment, a communication network form called P2P (Peer to Peer) has been adopted. P2P is a network form in which it is possible for direct information exchange to be made between an unspecified number of nodes, and is of two types, one of which requires the intervention of a central server and the other of which data is conveyed in a bucket brigade manner. Even when a central server is required, the central server provides a central file search database and only carries out connection management of the nodes, and the exchange of data is done by the direct connection between the nodes.

In the present preferred embodiment, a central server is not used, and communication is made by making a direct connection between nodes whose relationship has been established beforehand. With other nodes, communication is made by an indirect connection via the directly connected nodes. The authentication server 5 carries out only the management related to the authentication certificate, and does not have any direct relationship with the connection for communication between nodes. In addition, even the router 4 does not have any direct relationship with the connection for communication between nodes.

In P2P, since the nodes communicate directly with each other, how they authenticate each other's validity and how to control an illegal entry are very important in terms of security. A digital certificate issued by the authentication server 5 is used for this purpose.

In the following, in a network according to the present preferred embodiment, there will be described network connection management processing in which there are maintained more communication paths than a prescribed number in any two nodes, the communication paths between which two nodes do not pass through the same node, so that, even if some node gets disconnected from the network, the connection path between any node pair does not get cut off.

Configuration of Information Processing Apparatus as a Node:

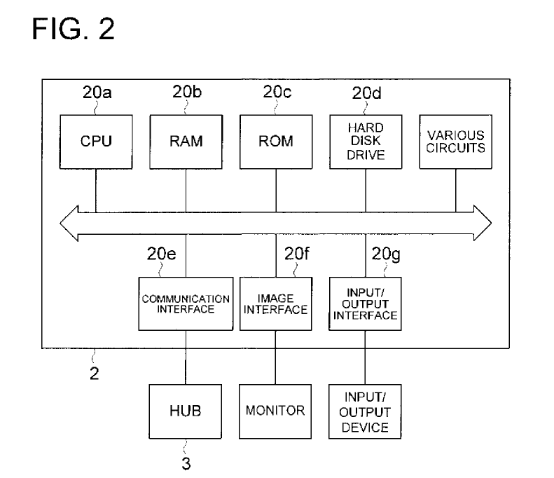

FIG. 2 is a diagram showing the hardware configuration of node 2.

The node 2, as is shown in FIG. 2, is configured to have a CPU 20a, RAM 20b, ROM 20c, hard disk drive 20d, communication interface 20e, image interface 20f, input/output interface 20g, and other various types of circuits or units.

The communication interface 20e is, for example, an NIC (Network Interface Card), and is connected by a twisted-pair cable to one of the ports of the switching hub 3. The image interface 20f is connected to a monitor and outputs a video signal to the monitor for displaying screen images.

The input output interface 20g is connected to input devices such as a keyboard, mouse, etc. and to external storage devices such as a CD-ROM drive, etc. Further, a signal indicating the contents of the operation made by the user in the input device is input from the input device. In addition, the data recorded in a recording medium such as a CD-ROM, etc., is read out by the external storage device and this signal is input. The data to be recorded in a recording medium is output to the external storage device.

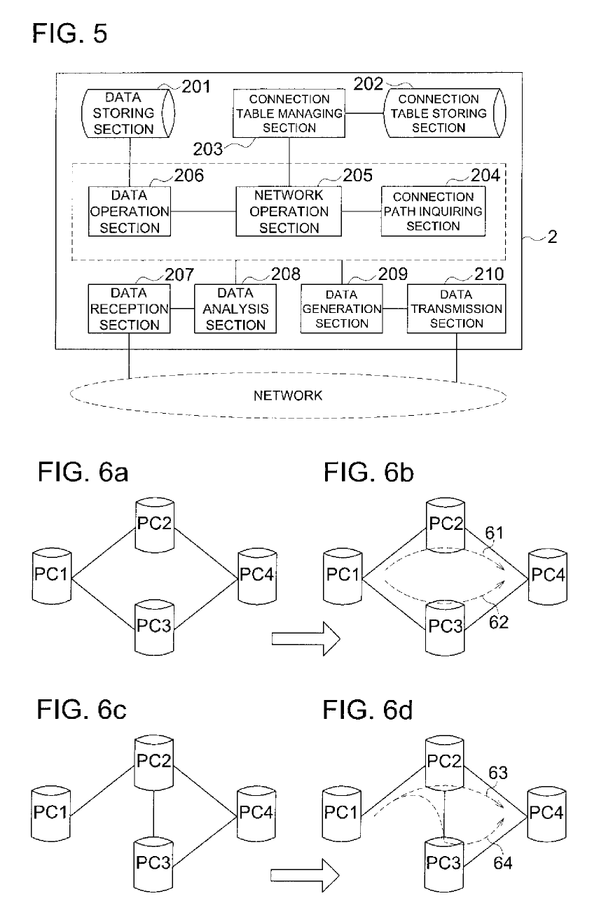

The hard disk drive 20d stores programs and data for realizing the functions of a data storing section 201, a connection table storing section 202, a connection table managing section 203, a connection path inquiring section 204, a network operation section 205, a data operation section 206, a data reception section 207, a data analysis section 208, a data generation section 209, and a data transmission section 210 (see FIG. 5). These programs and data are read into the RAM 20b if necessary, and the programs are executed by the CPU 20a.

For each node 2, a host name (machine name), an IP address, and a MAC address are assigned as the identification information so that each node can be distinguished from the other nodes. The host name can be assigned freely by a manger of the network 1. The IP address is assigned according to the rules of the network 1. The MAC address is a fixed address assigned to the communication interface 20e of that node 2. Further, instead of a MAC address, it is also possible to use some other unique ID.

In the present preferred embodiment, it is assumed that host names such as PC1, PC2, . . . , and so on have been assigned to the nodes 21, 22, . . . , and so on respectively. In the following, these nodes 2 may be referred to using their host names.

Connection Form of Nodes:

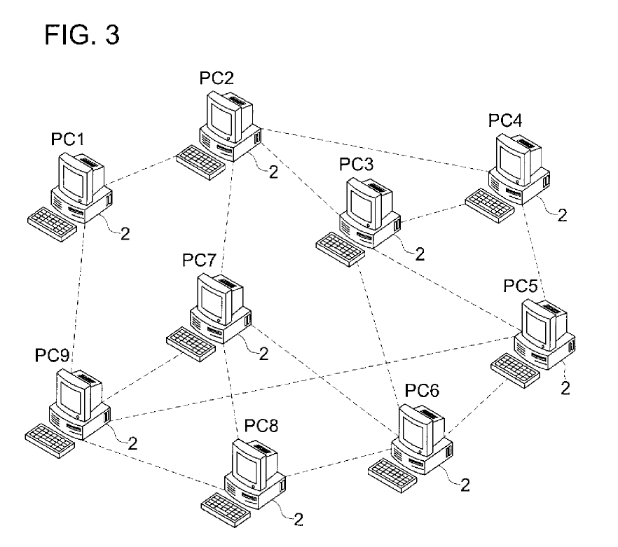

FIG. 3 is a diagram showing the connection form, or the logical topology, of the nodes.

As shown in FIG. 3, the nodes 2 are placed in a virtual space. Each node 2, as shown by broken lines, has a relationship established with at least one other node 2 within the virtual space. Because of these relationships, all the nodes have mutual relationships directly or indirectly with each other.

Further, “direct relationship” means that the nodes are connected mutually through a single broken line in FIG. 3 (for example, the relationship between PC1 and PC2), and “indirect relationship” means that the two nodes are connected mutually through two or more broken lines via one or more other nodes in between them (for example, the relationship between PC1 and PC4) Each node 2 transmits data to another node 2 with which it has a direct relationship.

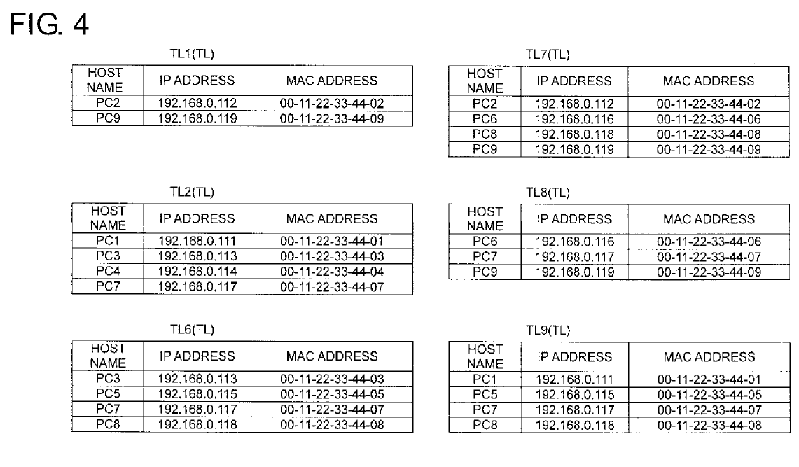

FIG. 4 is a diagram showing the connection tables TL of the nodes 2 whose relationships have been established as shown in FIG. 3. In each node 2, a list of information is stored as a connection table for connection with other nodes 2 with which the concerned node can transmit information directly, that is, with which it has a “direct relationship”.

In FIG. 3, PC1, PC2, PC6, PC7, PC8, and PC9 store the connection tables TL1, TL2, TL6, TL7, TL8, and TL9 as shown in FIG. 4.

Processing Functions of Different Sections of the Information Processing Apparatus:

FIG. 5 is a block diagram showing the functional configuration of the node 2.

The data storage section 201 stores as data files the data attributes indicating the attributes of node 2 or of it's user, data necessary for the authentication of that node 2 itself, data used by the operating system (OS) or by the application software programs, etc., data prepared by the user using an application software program, and various other types of data.

The data operation section 206, functioning as the updating section, stores the data in the data storing section 201, or carries out the process of updating the data stored in the data storing section 201, etc. For example, every time there is a change in the environment or the set contents of the node 2, the data attributes are updated. Further, the data operation section 206 carries out processing and temporary storage of the data obtained from other nodes.

The connection table storing section 202 stores a connection table TL indicating a list of the attributes such as the host name, IP address, MAC address, etc., of other nodes 2 with which that node has a direct relationship. The initial contents of such connection tables are prepared in advance by the manager based on the relationships established between the nodes.

The connection table managing section 203 carries out the management of the connection tables stored in the connection table storing section 202. The update processing is made for the connection table TL based on the connection information received from other nodes via the network operation section 205.

The network operation section 205 carries out processing when there is a change in the connection form of the network. For example, this carries out processing when a new node is attempting to participate in the network or when a node is attempting to leave the network. Further, this carries out the transmission and reception of connection information with other nodes 2 and contributes to connection management.

The connection path inquiring section 204 carries out inquiry of connection paths for execution of connection management of the network. Based on the inquiry results about the connection paths, the network operation section 205 transmits the necessary connection information to other nodes 2.

The data operation section 206 and the network operation section 205 function as a communication section, and when necessary, carry out data communication with the other nodes 2 of the network 1 via the data reception section 207 and the data transmission section 210, and when necessary, refer to or update the data of the connection table storing section 202 and of the data storing section 201.

The data reception section 207 carries out control processing necessary for data communication with other nodes 2. The data reception section 207 receives the packets necessary for that node 2 from among the packets flowing in the network 1.

The data analysis section 208 extracts the necessary data from the reception data received by the data reception section 207, and not only analyzes the contents of such extracted data but also judges the type of the received data.

The data generation section 209, prepares the transmission data to be transmitted to other nodes 2 based on the instructions from the data operation section 206, the network operation section 205, or from the connection path inquiring section 204, etc.

The data transmission section 210 converts the transmission data generated by the transmission data generation section 209 into packets and transmits them to other nodes 2.

Example of Processing Network Connection Management:

Processing Examples 1 to 3 for carrying out network connection management according to the present preferred embodiment will be explained.

These processing examples are the processes for preventing the network from being split by transmitting and receiving connection information in advance thereby securing a plurality of connection paths, between each pair of nodes, that do not pass through the same node in case of a node in the network being disconnected from the network due to some fault for example.

About connection paths that do not pass through the same node:

The reason for acquiring a plurality of connection paths, between each pair of nodes, that do not pass through the same node is that, even if there are several paths that pass through the same node between a pair, all of the plurality of paths will be lost when that same node is disconnected. On the other hand, when there are several paths, between each pair of nodes, which do not pass through the same node, only one of the paths is lost if one of the nodes is disconnected from the network.

As a consequence, when at least two paths not passing through the same node are secured between each pair of nodes, at least one of the paths is secured even if any node is disconnected from the network. In other words, in order to prevent the network from being split due to the disconnection of a node, it is necessary to secure at least two paths, between a node pair, which do not pass through the same node.

FIGS. 6a, 6b, 6c, and 6d are diagrams for explaining paths that do not pass through the same node.

FIG. 6a shows an example in which a network is constituted using direct relationships such as those shown by solid lines among the four nodes of PC1 to PC4. As is shown in FIG. 6b, the connection paths between PC1 and PC4 are a path 61 connected via PC2, and a path 62 connected via PC3.

Since these paths are via different nodes (PC2 and PC3), it means that there are two paths that do not go through the same node. Even if one of PC2 and PC3 gets disconnected, at least one path is secured between PC1 and PC4.

Although FIG. 6c, like FIG. 6a, shows an example of a network configured using four nodes PC1 to PC4, the connection relationships are different from those in FIG. 6a. As is shown in FIG. 6d, there are two connection paths between PC1 and PC4, one of which is a path 63 passing through only PC2, and the other of which is a path 64 passing through both PC2 and PC3.

Since the paths 63 and 64 are passing through the same node PC2, there are no multiple paths that do not pass through the same node. Therefore, if PC2 becomes disconnected, the connection between PC1 and PC4 gets cut off, and the network gets split.

Connection Form of the Entire Network:

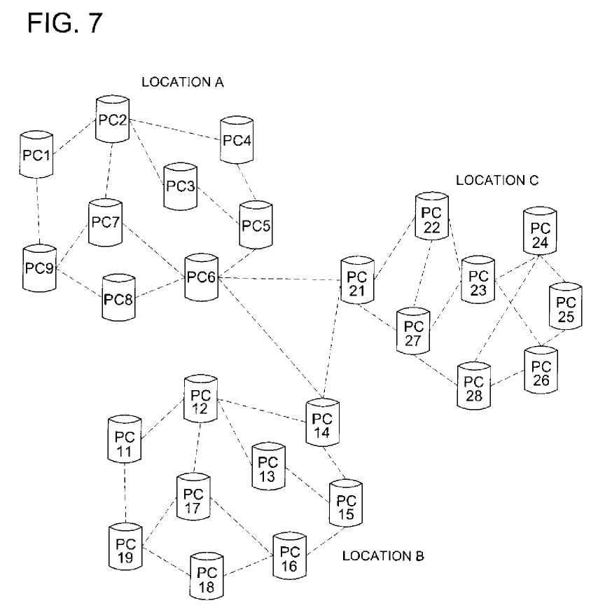

The different flows of processing examples 1 to 3 will be explained referring to an example of the connection relationships of a concrete network shown in FIG. 7.

In FIG. 7, the entire network has a network configuration of connecting three locations (locations A, B, and C) that are geographically separated from each other. Each location has a configuration of a respective sub-network, and the different sub-networks are connected together by a representative node at each location.

Location A has a sub-network configuration of the nodes PC1 to PC9 and is connected to location B and location C via PC6. Similarly, location B has a sub-network configuration of the nodes PC11 to PC19 and is connected to location A and location C via PC14. In a similar manner, location C has a sub-network configuration of the nodes PC21 to PC28, and is connected to location A and location B via PC21.

### Processing Example 1

In processing example 1, before a node becomes disconnected from the network, it transmits the connection table stored therein as connection information to all the nodes to which it is connected, and then the nodes that receive that information add the received connection table to the connection table stored therein to update their own connection tables.

To be prepared for some node to be disconnected from the network, before a node leaves the network, the node transmits connection information to the nodes to which it is directly connected so that a plurality of connection paths (that do not pass through the same node) between each pair of the nodes to which it is directly connected are secured after the node has becomes disconnected. The nodes which have received the connection information update their connection tables to establish a new connection path, and hence the network is prevented from being split.

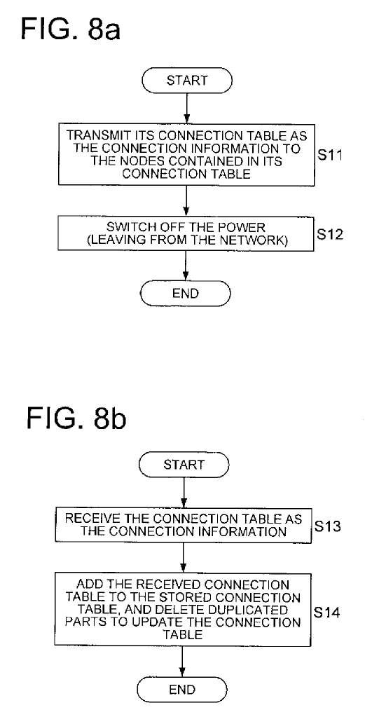

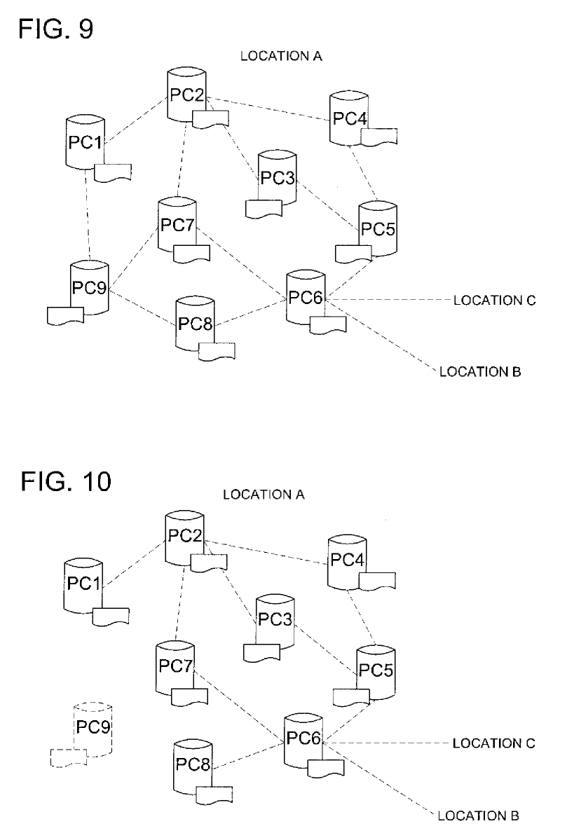

FIGS. 8a and 8b are flow charts showing the connection management procedures for processing example 1. Further, a concrete example of the connection management for processing example 1 is explained here using FIG. 9 to FIG. 12.

FIG. 8a shows the processing procedures in the transmitting side node, that is, in the leaving node. Also, FIG. 8b shows the processing procedures in a receiving side node, that is, in a node that is connected to the leaving node.

In Step S11 in FIG. 8a, the leaving node transmits its connection table as the connection information in advance to the nodes to which it is directly connected, that is, to the nodes present in the connection table storied by the leaving node. The network operation section 205 in FIG. 5 refers to the connection table stored in the connection table storing section 202, and transmits that connection table as the connection information to each of the nodes listed in that connection table.

Next, in Step S12, the node, which has completed transmission, switches OFF its power supply, for example. In other words, it leaves the network and ends its processing.

On the other hand, in Step S13 in FIG. 8b, a node connected to the leaving node receives the connection table as the connection information from the leaving node.

Next in Step S14, the node which has received the connection table adds the connection table received as the connection information to the connection owned thereby, deletes duplicated parts to update its connection table. The connection table management section 203 in FIG. 5 adds the connection table received as the connection information to the connection table stored in the connection table storing section 202, deletes duplicated parts to update its connection table.

By updating the connection table, new connection paths are established, and the processing is ended. Because of this, splitting of the network due to the disconnection of a node is prevented.

FIG. 9 shows a sub-network at the location A in the network shown in FIG. 7. The connection relationships of each node are shown by broken lines. In this sub-network made of the nodes PC1 to PC9, an example of the case in which PC9 is going to leave the network is explained here.

FIG. 10 shows the situation that PC9 has left the network in the case where the connection management according to the present preferred embodiment is not carried out. At this point in time, although splitting of the network has not taken place, for example, PC1 and PC8 have only one connection path with other nodes. If a node further becomes disconnected, the network may be split.

For example, if PC2 becomes disconnected, PC1 becomes disconnected from the network. Also, if PC6 becomes disconnected, PC8 becomes disconnected from the network. In addition, when PC6 becomes disconnected, all of the nodes at location A become separated from the nodes at location B and location C, and this will be explained in the processing example 2.

From the point of view of preventing the splitting of the network, as has already been explained, each pair of nodes preferably has always multiple paths that do not pass through the same node. The processing required for this is being executed in this processing example 1. In other words, the leaving node (PC9) transmits in advance the connection information (the connection table of PC9) to the nodes (PC1, PC7, and PC8) to which it is directly connected.

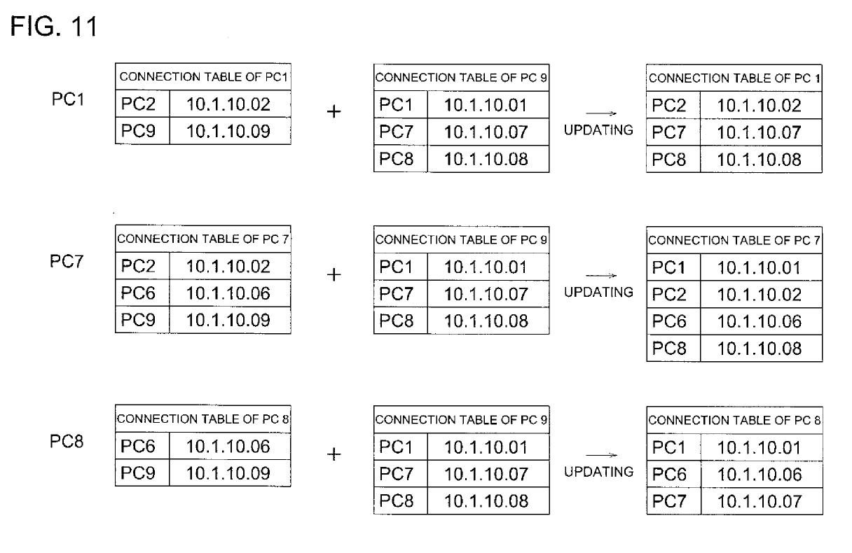

FIG. 11 is a diagram showing the connection table transmitted as connection information, and the updating of the connection table in the receiving nodes based on that. Each of the connection tables of PC1, PC7, and PC8 is updated by adding the received connection table from PC9, and each of them establish a new connection path based on the new connection table.

In PC1, the connection table of PC9 is added to the connection table of PC1, itself (PC1) and the transmitting node (PC9) are deleted from the connection table, and the table is updated. In other words, instead of the lost connection path with PC9, the connection paths with PC7 and PC8 are established.

Further, in PC7, instead of the lost connection path with PC9, the connection paths with PC1 and PC8 are established. Similarly in PC8, instead of the lost connection path with PC9 being lost, the connection paths with PC1 and PC7 are established.

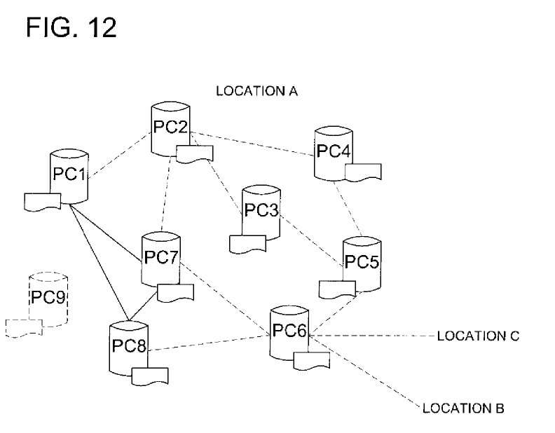

FIG. 12 is a diagram showing the situation that PC9 has left the network and the connection management for processing example 1 has been carried out. PC1 and PC8 have established new connection paths shown by solid lines, two or more connection paths (that do not pass through the same nodes) are secured with other nodes. Even if there is another disconnection of node, still newer connection paths are opened, and at all times two or more connection paths with other nodes are secured. Therefore, splitting of the network will not possibly occur.

### Processing Example 2

In processing example 2, before a prescribed node leaves the network, it selects an alternative node from among the nodes to which the prescribed node is directly connected, transmits its connection table as connection information to that alternative node, and the alternative node having received the connection table adds that connection table to its own connection table to update it.

For example, in case of disconnection of the node located at the position of connection to other locations, the leaving node selects in advance the alternative node from the nodes to which the leaving node is directly connected, and sends the connection information to the alternative node. Then the alternative node establishes new connection paths to prevent the network from being split.

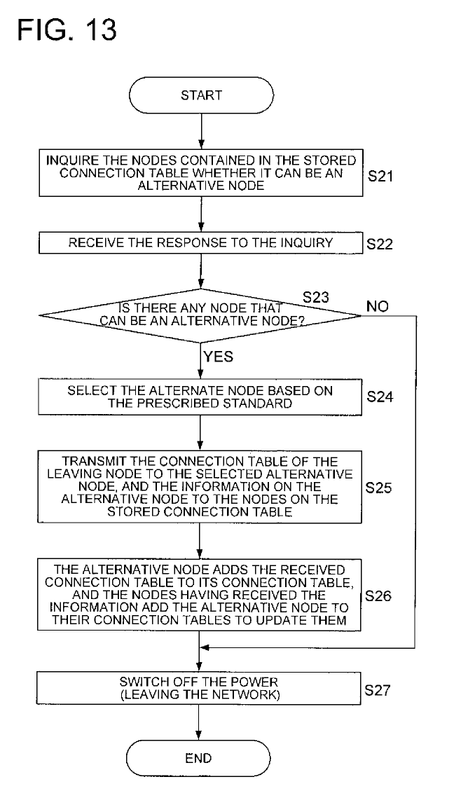

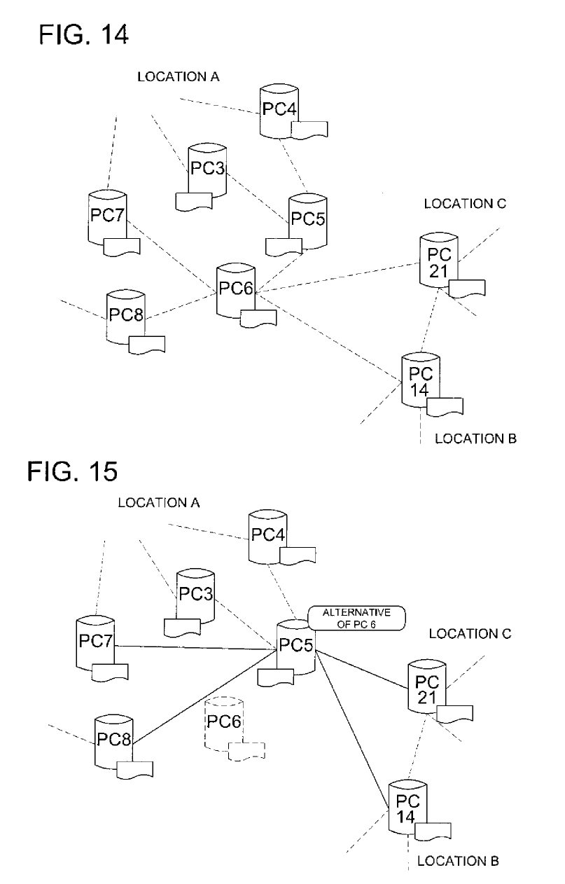

FIG. 13 is a flow chart showing the connection management procedure of processing example 2. Further, a concrete example of connection management for processing example 2 will be explained using FIG. 14 and FIG. 15.

In Step S21 of FIG. 13, the leaving node, that is, the representative node that is connected to other locations, transmits in advance to each of the nodes to which it is directly connected, that is, to the nodes listed in its connection table, an inquiry as to whether they can act as a representative node. The network operation section 205 in FIG. 5 refers to the connection table stored in the connection table storing section 202, and transmits the above inquiry to each of the nodes listed in that connection table.

Next, in Step S22, a response is received from each of the nodes that have received the inquiry.

In Step S23, referring to the responses from each of the nodes, a judgment is made as to whether or not there is a node that can be an alternative node. If there is a possible node (YES in Step S23), Step S24 is executed next. If there is no possible node (NO in Step S23), the operation proceeds to Step S27.

In most cases, there is a node that can become an alternative node However in the case in which all the nodes at the location leave and the sub-network itself at that location is halted, there is no node that can become an alternative node. In such situations, Step S27 is executed, and the processing is ended after the leaving node leaves the network.

In Step S24, since there is a node that can become an alternative node, one alternative node is selected based on some prescribed standard. The prescribed standard can be the way, for example, the first responding node will be the alternative node, or can be some order of priority determined in advance.

In Step S25, the connection table of the leaving node is transmitted to the selected alternative node as the connection information. At the same time, the information about the alternative node is posted to each of the nodes to which the leaving node is connected directly, that is, to the nodes listed in the connection table of the leaving node.

Next, in Step S26, the alternative node having received the connection table adds the connection table received as the connection information to the connection table stored therein, deletes duplicated parts to update the connection table. Further, each node that has received posting about the alternative node deletes the information of the leaving node from its own connection table, adds the information about the alternative node to update the connection table.

The connection table management section 203 in FIG. 5 adds the information of the connection table received as the connection information to the connection table stored in the connection table storing section 202, or else, adds the information of the posted alternative node, deletes duplicated parts to update its connection table.

By updating the connection table, new connection paths are established, and the processing is ended, so that disconnection of the network with other locations due to the disconnection of a node is prevented.

Next, in Step S27, the leaving node switches OFF its power supply. In other words, it lets the alternative node take care of the connection with other locations, leaves the network, and ends its processing.

FIG. 14 is a diagram showing a part of the sub-network at location A in the network of FIG. 7. The connection relationships between the nodes are shown by broken lines. In the sub-network at this location A, the connections with the sub-networks at the other locations B and C are always being made via PC6.

FIG. 15 is a diagram showing the situation after PC6 has left the network, and the connection management for processing example 2 has been carried out.

At this point of time, if the connection management according to the present preferred embodiment is not carried out, in FIG. 15, the connection paths shown by solid lines are not established, and only the connection paths indicated by broken lines remain. In other words, the network gets split, and the nodes such as PC7 or PC8 inside location A have lost their connection paths with the nodes in location B or in location C.

From the point of view of preventing splitting of the network, as has already been explained, it is desirable that at all times multiple paths are present, between each pair of nodes, that do not pass through the same node. The processes are being made in this processing example 2 in the special case in which there is always only one connection path that does not pass through the same node, to put it more particularly, the are processes being made in the case in which a connection path between locations have to go through one node, which represents the location, and that representative nodes is leaving the network.

The leaving node (PC6) in location A selects an alternative node in advance by transmitting to each of the nodes to which it is directly connected (PC5, PC7, and PC8) an inquiry as to whether they can act as an alternative node.

Here, we shall assume that PC5 has been selected as the alternative node among the nodes that can become alternative nodes.

Once the alternative node is determined, the leaving node (PC6) transmits to the alternative node (PC5) the connection table stored therein as the connection information, and the alternative node (PC5) adds that connection table to the connection table stored therein to update it.

As the connection destination of PC5, PC6 is deleted, and PC7, PC8, PC14 of location B, and PC21 of location C are newly added.

Further, the leaving node (PC6) communicates information on PC5 as the connection information to other nodes (PC7, PC8, PC14 of location B, and PC21 of location C). These nodes add PC5 as their connection destination to their connection tables to update them.

In this manner, the connection paths between nodes indicated by solid lines in FIG. 15 are established, each node in location A will have connection paths with nodes in locations B and C because of passing through the alternative node (PC5) at all times, and splitting of the network between locations is prevented.

### Processing Example 3

In processing example 3, the number of connection paths between nodes is investigated, if there is a node pair in which the number of connection paths that do not pass through the same node is less than a prescribed number, the data transmission section 210 transmits to each node of the concerned node pair information on the counterpart node to which it should be additionally connected, and the node having received the information adds the information of the counterpart node indicated in that connection information to the connection table stored therein to update it.

The number of connection paths, in a node pair, that do not pass through the same node is investigated for each of the nodes within the network, and if the prescribed number of paths are not secured, in order to prevent splitting of the network, the information on the counterpart node to which each node of the concerned node pair should be additionally connected is transmitted to each node of the concerned node pair to cause them to update their connection tables and to establish new connection paths, thereby securing the prescribed number of connection paths at that point of time and preventing splitting of the network.

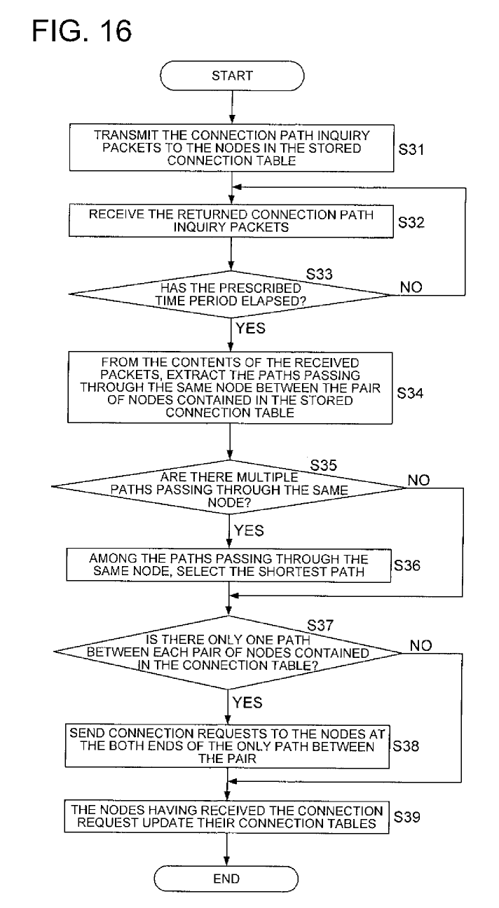

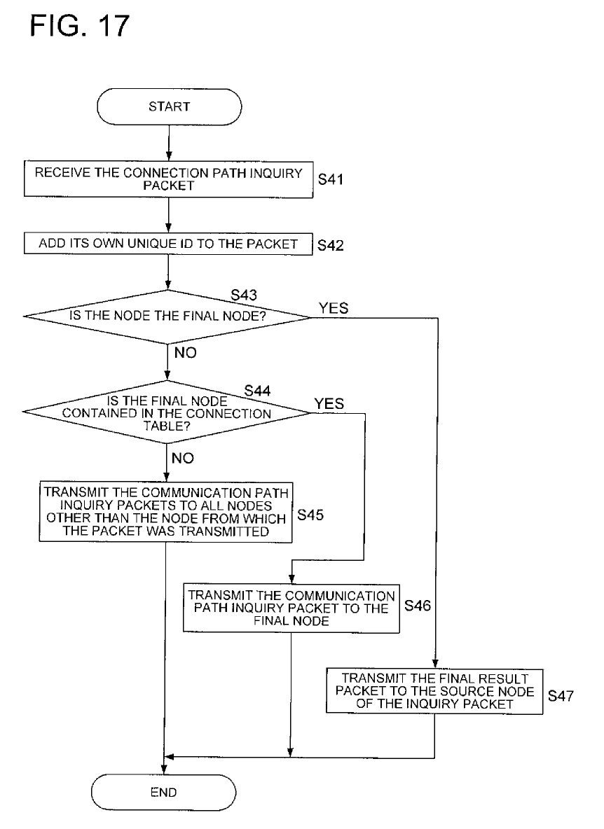

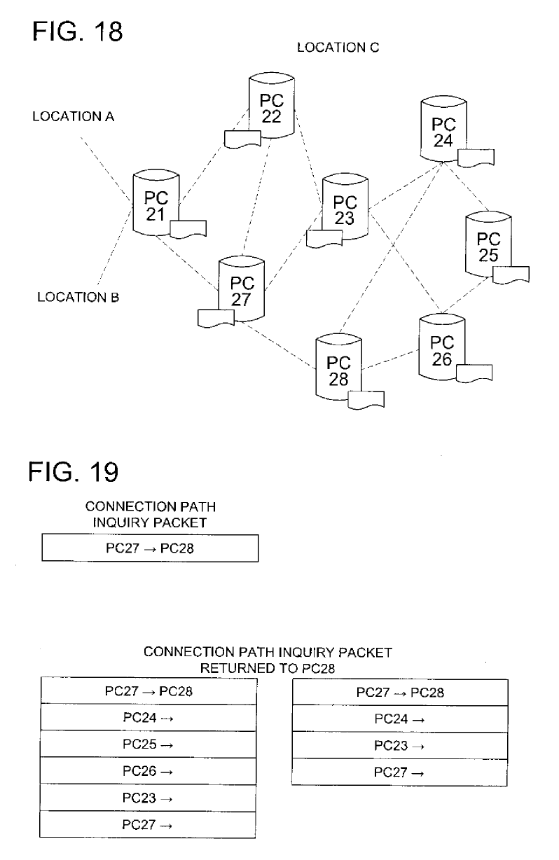

FIG. 16 and FIG. 17 are flow charts showing the connection management procedures according to processing example 3. Further, a concrete example of connection management for processing example 3 will be explained using FIG. 18 to FIG. 20.

FIG. 16 shows the processing procedures of the transmitting side node, that is, the node that is carrying out the connection path inquiry. Also, FIG. 17 shows the processing procedures of the receiving side node, that is, a node that receives the path inquiry packet transmitted by the node carrying out the connection path inquiry, the node where a prescribed processing is executed on the received packet and the packet is transmitted to other node.

The Steps S31 to S36 of FIG. 16 and the Steps S41 to S47 in FIG. 17 correspond to the connection path inquiry. These processes are controlled by the connection path inquiring section 204 in cooperation with the network operation section 205 of FIG. 5.

This connection path inquiry can be carried out using any publicly known technology. Here, we shall assume that it is carried out using a method called the flooding technique.

In Step S31 in FIG. 16, the node carrying out the connection path inquiry transmits the connection path inquiry packet to all the nodes to which it is directly connected, that is, to all the nodes in the connection table stored therein.

Next, in Step S32, the node, after the transmission, receives the returned connection path inquiry packets.

In Step S33, a judgment is made as to whether or not a prescribed time period has elapsed. By ignoring paths that take more than the prescribed time period to return the path inquiry packet, wasteful paths are eliminated.

If the prescribed time period has not elapsed in Step S33 (NO in Step S33), the operation returns to Step S32, and continues to receive the returned path inquiry packets. If the prescribed time period has elapsed (YES in Step S33), Step S34 is executed.

Here, moving to FIG. 17, the processing procedures in the node receiving the path inquiry packet will be explained.

In Step S41 of FIG. 17, the nodes connected to the node carrying out the communication path inquiry receive the path inquiry packets.

Next, in Step S42, the nodes that having received the path inquiry packet add their ID, unique to the node, to the received path inquiry packet. This ID shows that the path inquiry packet goes through that node.

In Step S43, the information on the final node given in the path inquiry packet is referred to, and a judgment is made as to whether that node itself is the final node. The final node is one that has been specified to return the packet to the source node of the path inquiry packet, that is, to the node carrying out the communication path inquiry.

In Step S43, if it is judged that that node itself is the final node (YES in Step S43), Step S47 is executed, and the path inquiry packet (the final result packet) is transmitted and returned to the node to which it has to be returned, that is, to the source node of the path inquiry packet. If that node itself is not the final node (NO in Step S43), Step S44 is executed.

In Step S44, a judgment is made as to whether or not the final node is written in the connection table stored therein. If the final node is present in the connection table (YES in Step S44), Step S46 is executed, and the path inquiry packet is sent only to the final node. If the final node is not present in the connection table (NO in Step S44), Step S45 is executed.

In Step S45, the path inquiry packet is transmitted to all the nodes listed in the connection table except the node from which that node received the packet.

The path inquiry packet will be transmitted to the next node in either of the steps Step S45 or Step S46. If the node receives another path inquiry packet, the steps are repeated from the first step S41.

Returning to FIG. 16, explanations are continued from the point that the path inquiry packet has been returned within the prescribed time period to the node that is carrying out the communication path inquiry. The returned path inquiry packets reflect the number of paths, and the number of paths contained in the returned packet is greater than that at the time of the packet being sent. From those, in order to obtain the number of paths that do not pass through the same node, the shortest path is extracted from the paths that pass through the same node.

In Step S34, referring to the contents of each of the received packets, the paths, which pass through the same node between a pair of the specific nodes in the connection table, are extracted.

In Step S35, a judgment is made as to whether or not there are a plurality of extracted paths that pass through the same node. If there are a plurality of paths (YES in Step S35), Step S36 is executed. If there are not, Step S37 is executed.

In Step S36, only the shortest path is selected from the plural number of paths passing through the same node and is retained, which means that only the connection paths that do not pass through the same node are retained as the connection paths.

From here onwards, the processing is for securing plural number of paths, between each pair of nodes, that do not pass through the same node.

In Step S37, a judgment is made as to whether the number of paths between two specific nodes in the connection table is one or not. In other words, this means that whether or not the number of paths not passing through the same node is one or not. If the number of paths is one, Step 38 is executed. The processing ends if the number of paths is two or more.

In Step S38, a connection request, with the information on a counterpart node to be additionally connected to, is transmitted to the node pair which has only one connection path not passing through the same node, that is, for the two ends of the path.

In Step S39, each of the nodes having received the above connection request add the received information on the additional counterpart node to the connection tables stored therein to update the connection table. Because of updating the connection tables, new connection paths are established, and the numbers of paths, between a node pair, that do not pass through the same node become more than one.

The processing is ended at this point. By appropriately carrying out this connection path inquiry, a plural number of connection paths, between each pair of nodes, that do not pass through the same node are secured at that time and without the node carrying out the connection path inquiry, and hence any splitting of the network due to a sudden disconnection of a node is prevented.

FIG. 18 shows the sub-network at the location C in the network of FIG. 7. The connection relationships between the different nodes are shown by broken lines. In this sub-network having the nodes PC21 through PC28, a concrete example is explained below for the example of the case in which PC28 carries out connection path inquiry.

FIG. 18 shows the situation in which a connection path inquiry is about to be executed. At this point in time, although the network has not been split, if PC28 becomes disconnected, the number of connection paths between node pairs having a connection path passing through PC28 may become only one. If there is only one path, between each pair of nodes, that passes through the same node, the network may gets split when further disconnection of node occurs.

Here, PC28 carries out the connection path inquiry to figure out the number of paths, between each pair of the nodes (PC24, PC26, and PC27) connected to PC28, that do not pass through the same node, and takes measures so that the number of such paths is plural without PC28. In other words, the path inquiry is made for the three node pairs of PC24 and PC26, PC27 and PC24, and PC26 and PC27.

To begin with, PC28 sets, for example, PC27 as the final node. Further, it specifies that the packet must be returned to PC28 after passing through the final node (PC27). And then it transmits these path inquiry packets to the other nodes (PC24 and PC26) in the connection table.

FIG. 19 shows the path inquiry packet transmitted by PC28 to PC24 and the path inquiry packets that are returned to PC28 as a result of the inquiry.

The transmitted path inquiry packet specifies that it be returned to PC28 via the final node (PC27). The IDs of the nodes that the packet has passed through are added sequentially in the returned path inquiry packet, and it is possible to trace the path which the packet has followed.

When PC24 receives the path inquiry packet, the final node is PC27. However, PC24 is not directly connected with PC27. Therefore, PC24 transmits the path inquiry packet to PC23 and PC25 with which it is directly connected. At that time, it adds its own ID (PC24) to the path inquiry packet.

Similarly, PC25 having received that path inquiry packet adds its own ID (PC25) to that packet and transmits it to PC26 which is the only node to which PC25 is directly connected other than the transmission source node PC24.

Similarly, PC26 having received the packet adds its own ID (PC26) to the packet and transmits it to PC23, but does not send it to PC28. The transmission to PC28 is made only by the final node.

PC23 receives two path inquiry packets. Since PC23 is connected with the final node (PC27), it adds its own ID (PC23) to both of the received packets and transmits them both to the final node (PC27).

The final node (PC27) adds its own ID (PC27) to all the received packets and transmits them to the return destination node (PC28).

In FIG. 19 shows the two path inquiry packets that have followed the above paths.

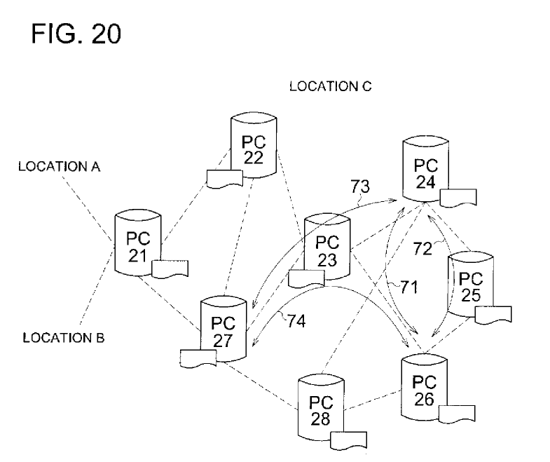

In this manner, it is possible to obtain the paths that include the paths between the nodes (PC24, PC26, and PC27) that are connected to PC28. FIG. 20 shows the paths that are extracted from these paths and do not pass through the same nodes.

In FIG. 20, if PC28 is excluded, the paths have PC24 and PC26 on their both ends and do not pass through the same nodes are two paths, where one is path 71 via PC23 and the other is path 72 via PC25. However, the path which has PC27 and PC24 on its both ends and does not pass through the same node is only one, namely, path 73 via PC23. In addition, there is also only one path which has PC26 and PC27 on its both ends and does not pass through the same node is only one, namely, path 74 via PC23.

Therefore, if PC28 becomes disconnected from the network, there will be only one path remaining between PC27 and PC24 and between PC26 and PC27. In order to prevent splitting of the network due to another disconnection of node, in this processing example 3, measures are taken to secure, at this point and without PC28, multiple paths, between each pair of nodes, that pass through the same node.

In other words, PC28 carrying out the path inquiry packets sends to PC27 and PC24 a connection request with the notice of the information on each other node as an additional counterpart node to be connected to in order to establish a new connection path between PC27 and PC24. In addition, in a similar manner, it also sends to PC26 and PC27 a connection request with the notice of the information on each other node as an additional counterpart node to be connected to in order to establish a new connection path between PC26 and PC27. This makes it possible to secure a plural number of paths, between each pair of nodes, that do not pass through the same node, and even if there is a sudden disconnection of a node, it is possible to prevent the network from getting split.

Further, such connection path inquires may be periodically executed, or it can also be done at appropriate times when the disconnection of a node is predicted in advance.

In this manner, according to the present preferred embodiment, by transmitting and receiving connection information between nodes at prescribed timing, and by updating the stored connection tables based on the received connection information, connection paths, between each pair of nodes, that do not pass through the same node can be maintained more than a prescribed number.

This measure realizes an effective management of the connection paths between the nodes, that is, an effective management of the network, where there is no need for wastefully setting or maintaining connection paths more than a needed number, and the connection paths between nodes can be secured even in the situation of a sudden disconnection of a node and the like.

Further, the scope of the present invention is not to be limited to the above preferred embodiment. All the modified forms that do not depart from the spirit of the present invention shall be construed to be within the scope of the present invention.

What is claimed is:

1. A method for managing connection between a plurality of nodes which constitute a network, the method comprising the steps of:
providing each of the plurality of nodes with a connection table which contains connection information for connecting to one or more other nodes;
transmitting connection information from a first node of the plurality of nodes to a second node of the plurality of nodes at a predetermined timing; and
updating the connection table stored in the second node based on the connection information transmitted from the first node to the second node,
wherein the connection information is transmitted from the first node to the second node so that a number of connection paths which connect a pair of the plurality of nodes and do not pass through a same node is maintained to be a predetermined number or more.

2. The method of claim 1, wherein the first node transmits the connection information to the second node before the first node leaves the network.

3. The method of claim 1, wherein the first node transmits the connection table owned by itself, as the connection information, to the second node.

4. The method of claim 1, wherein the first node assumes the respective node contained in the connection table owned by the first node to be the second node and transmits the connection information thereto.

5. The method of claim 1, wherein the first node selects a node assumed to be the second node from one or more nodes contained in the connection table owned by the first node and transmits the connection information to the selected node.

6. The method of claim 1, further comprising the step of:
inquiring a number of said connection paths which do not pass through a same node.

7. The method of claim 6, further comprising the step of:
adding an additional connection path to between a pair of the nodes of which the number of the connection paths obtained in the step of inquiring is less than the predetermined number.

8. The method of claim 7, wherein the step of adding a connection path includes the step of:
transmitting connection information of the additional connection path to each of the pair of the nodes of which the number of the connection paths obtained in the step of inquiring is less than the predetermined number.

9. An information processing apparatus as a node of a network constituted of a plurality of nodes, the information processing apparatus comprising:
a storing section which is adapted to store a connection table containing connection information for connecting to one or more other nodes;
a communication section which is adapted to communicate with said other node based on the connection table stored in the storing section;
a transmission section which is adapted to transmit connection information to said other node at a predetermined timing;
a reception section which is adapted to receive connection information from other node; and
an updating section which is adapted to update the connection table stored in the storing section based on the connection information received by the reception section,
wherein the connection information is transmitted by the transmission section so that a number of connection paths which connects a pair of the plurality of nodes and do not pass through a same node is maintained to be a predetermined number or more.

10. The information processing apparatus of claim 9, wherein the transmission section transmits the connection information to said other node before the information processing apparatus leaves the network.

11. The information processing apparatus of claim 9, wherein the transmission section transmits the connection table stored in the storing section as the connection information.

12. The information processing apparatus of claim 9, wherein the transmission section transmits the connection information to the respective node contained in the connection table stored in the storing section.

13. The information processing apparatus of claim 9, wherein the transmission section select a node to which the connection information should be transmitted, from one or more other nodes contained in the connection table stored in the storing section and transmits the connection information to the selected node.

14. The information processing apparatus of claim 9, further comprising:
an inquiry section which is adapted to inquire a number of said connection paths which do not pass through a same node.

15. The information processing apparatus of claim 14, wherein the transmission section transmits connection information of an additional connection path to each of the pair of the nodes of which the number of the connection paths obtained by the inquiry section is less than the predetermined number.
